(19) United States
(12) Patent Application Publication
(10) Pub. No.: US 2016/0079914 A1
(43) Pub. Date: Mar. 17, 2016

(54) INTEGRATED TRACKER CONTROLLER

(71) Applicants: Junbo Wu, San Jose, CA (US); Keith Johnston, Palo Alto, CA (US); Chen-An Chen, San Jose, CA (US); Zachary S. Judkins, Berkeley, CA (US)

(72) Inventors: Junbo Wu, San Jose, CA (US); Keith Johnston, Palo Alto, CA (US); Chen-An Chen, San Jose, CA (US); Zachary S. Judkins, Berkeley, CA (US)

(21) Appl. No.: 14/853,865

(22) Filed: Sep. 14, 2015

Related U.S. Application Data
(60) Provisional application No. 62/050,883, filed on Sep. 16, 2014.

(51) Int. Cl. H02S 20/32; H02S 40/34; H02S 40/32

(52) U.S. Cl. CPC H02S 20/32; H02S 40/32; H02S 40/34

(57) ABSTRACT

A photovoltaic (PV) system is disclosed. The PV system can include a first and a second tracker that includes a first and a second plurality of PV collection devices. The PV system can include a first motor configured to adjust an angle of the first tracker. The PV system can include an inverter coupled to an output of the first plurality of PV collection devices. The inverter can include a first local controller comprising control circuitry configured to control the first motor. In an example, the inverter can be a string inverter. In one example, the inverter can a block inverter coupled to an output of the first and second plurality of PV collection devices. The PV system can also include a power collection unit, where the power collection unit can be coupled to the first plurality of PV collection devices and include the first local controller. The PV system can also include a central controller configured to provide a first indication to the first local controller, where the first indication is usable by the control circuitry of the first local controller to control the first motor.

### CROSS-REFERENCE TO RELATED APPLICATIONS

This application claims the benefit of U.S. Provisional Application No. 62/050,883, filed on Sep. 16, 2014, the entire contents of which are hereby incorporated by reference herein.

### BACKGROUND

Photovoltaic-based energy generation systems can include an array of photovoltaic (PV) modules. The array of PV modules can include tracking capabilities that allow the PV modules to track the sun as the sun traverses the sky to improve energy production of the system. In some systems, one or more block inverters can be used to convert direct current (DC) that is output from the PV modules into alternating current (AC). The AC current can then be combined in a combiner box, which can then be provided to an electrical grid.

### BRIEF DESCRIPTION OF THE DRAWINGS

FIG. 1 is a schematic top plan view of a solar tracker system, according to some embodiments.

FIG. 2 is a side view of an example concentrator solar tracking system, according to some embodiments.

FIG. 3 is a block diagram of an example control system for a solar tracker system, according to some embodiments.

FIG. 4 is a block diagram of another example control system for a solar tracker system, according to some embodiments.

FIG. 5 is a block diagram of still another example control system for a solar tracker system, according to some embodiments.

FIG. 6 is a block diagram of an example computer system configured to implement one or more of the disclosed techniques, according to some embodiments.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” tracker of plurality of PV trackers does not necessarily imply that this tracker is the first tracker in a sequence; instead the term “first” is used to differentiate this tracker from another tracker (e.g., a “second” tracker).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the description set forth below, a photovoltaic-based energy generation system, also referred to as a photovoltaic (PV) system, is described in the context of an embedded local controller, a central controller, and a tracker with the local controller being configured to control a motor of the tracker to adjust the PV collection devices (e.g., PV modules or concentrated PV receivers) for sun-tracking purposes. In one embodiment, the PV system can include at least one PV tracker system. In various embodiment, the local controller can be embedded in a block inverter, a string inverter or a power collection unit (e.g., combiner box). As used herein, the term tracker can include the PV modules or receivers, support structure, drive, wiring, and/or motor to effectuate the tracking. The tracker can be coupled to one or more controllers and/or other devices, which can cause the tracker to change its orientation.

This specification first describes example trackers that can be used with the disclosed control system, followed by more detailed examples of control systems. Numerous examples are provided throughout.

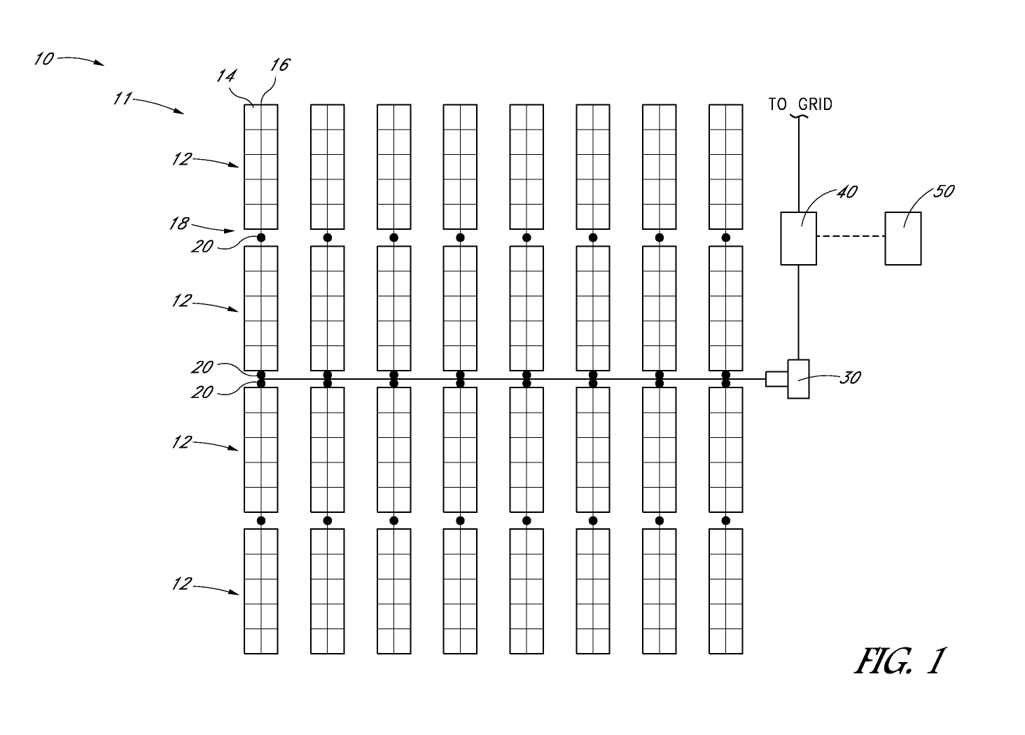

FIG. 1 illustrates solar collection system 10, which can be considered a PV power plant. The solar collection system 10 includes solar collector array 11 which includes a plurality of PV modules 12. Each of the PV modules 12 can include a plurality of solar collecting devices 14 (e.g., solar cells) incorporated into a laminate and encircled by a peripheral frame, with PV module 12 being supported by a drive shaft or torque tube 16. Each of the torque tubes 16 are supported above the ground by support assembly 18. Each of support assemblies 18 can include a pile and a bearing assembly 20.

With continued reference to FIG. 1, system 10 can also include tracking drive 30 connected to torque tube 16 and configured to pivot torque tube 16 so as to cause collector devices 14 to track the movement of the sun. In the illustrated embodiment, torque tubes 16 are arranged generally horizontally and PV modules 12 can be connected to each other and torque tubes 16. However, embodiments disclosed herein can be used in the context of other types of arrangements. For example, system 10 can include a plurality of modules 12 that are arranged such that torque tubes 16 are inclined relative to horizontal, wherein torque tubes 16 are not connected in an end to end fashion. Further, embodiments disclosed herein can be used in conjunction with the systems that provide for controlled tilting about two axes, although not illustrated herein.

Additionally, solar collection devices 14 can be in the form of PV modules, thermal solar collection devices, concentrated PV devices, or concentrated thermal solar collection devices. In the illustrated embodiment, the solar collection devices 14 are in the form of non-concentrated PV modules 12.

In various embodiments, tracking drive 30 can include a motor and one or more sensing devices such as an inclinometer so as to measure an angle of inclination. In one embodiment, tracking drive 30 can be coupled to a local controller 40, which can include one or more components configured to cause the motor to actuate. For example, as described herein, in one embodiment, local controller 40 can include a motor starter and one or more relays. In one example, the local controller can control the movement of the motor by sending an indication (e.g., using a motor starter and relays) based on telemetry data and/or a tracking angle to motor.

In one embodiment, local controller 40 can be located within a string inverter. A string inverter can be a local inverter corresponding to a particular tracker and can be configured to convert direct current (DC) power received from the output of the solar collection devices into alternating current (AC) power, which can be provided to the grid, for example, after being modified by a step-up transformer. The string inverter can also be configured to provide AC power to the tracker motor in an embodiment using an AC motor. In one embodiment, the local controller 40 can receive voltage from the string inverter, the grid or a battery.

In an embodiment, local controller 40 can be located within a block inverter. A block inverter can be an inverter configured to convert direct current (DC) power received from the output of a plurality of PV tracker systems 10 into alternating current (AC) power, which can be provided to the grid, for example, after being modified by a step-up transformer. The block inverter can also be configured to provide AC power to the motors of the plurality of solar collection systems 10. In an embodiment, the block inverter can include one or a plurality of local controllers, each corresponding to a PV tracker, respectively. In one embodiment, the local controller 40 can receive voltage from the block inverter, the grid or a battery.

In some embodiments, the local controller 40 can be located in a power collection unit. A power collection unit can be a collection unit configured to combine the direct current (DC) output by of solar collection devices 14 to a single direct current (DC) output of the solar collection system 10 (e.g., a DC combiner box). In an example, the power collection unit can be coupled to the block inverter, where the block inverter can convert direct current (DC) power received from the output of a plurality of solar collection systems 10 into alternating current (AC) power. In one embodiment, the power collection unit can be a collection unit configured to collect alternating current (AC) power received from an output of a plurality of string inverters (e.g., an AC combiner box), where the power collection unit can further be connected to the grid. In an example, the power collection unit can be connected to the grid after being modified by a step-up transformer. In an embodiment, a single or multiple power collection units can be used. The power collection unit can also be configured to provide DC power to the motors of the plurality of solar collection systems 10. In some embodiments, the motors can receive voltage directly from the grid or from a battery.

As shown in the example of FIG. 1, local controller 40 can be communicatively coupled with central controller 50. In various embodiments, central controller 50 can be configured to communicate with a plurality of local controllers 40 over a wireless mesh network (e.g., ZigBee, DigiMesh, etc.), other wireless network protocols (e.g., WiFi, WiMax, LTE, cellular networks, etc.), or even a wired network. In various embodiments, control and/or status information can be exchanged between central controller 50, local controller(s) 40, and/or a remote computing device (not shown). Various command and telemetry data can be exchanged between a local controller 40, central controller 50, and the remote computing device. As used herein, status information, commands and/or telemetry data can also be referred to as a status indication and/or an indication. In one embodiment, the central controller 50 can be located within a block inverter. In some embodiments, the central controller can be offsite (e.g., at a different location from the PV system altogether).

Collectively, the central controller, local controllers, and/or the remote computing device can be configured to receive data, analyze that data, and compute the appropriate tracking angles and based on those computations, provide an indication to the tracker motor to move in a forward or reverse direction. For a two-axis tracker, such analysis can be performed in both axes and separate indications can be provided to separate motors when appropriate. In an example, the central controller, local controllers, and/or the remote computing device can provide an indication to the tracker motor to adjust an angle of the tracker based on the tracking angle. In some embodiments, the motor itself can include circuitry to receive data from the central controller or local controller, analyze that data, and compute the appropriate tracking angles from that data and move to a specific angle and/or direction based on those computations.

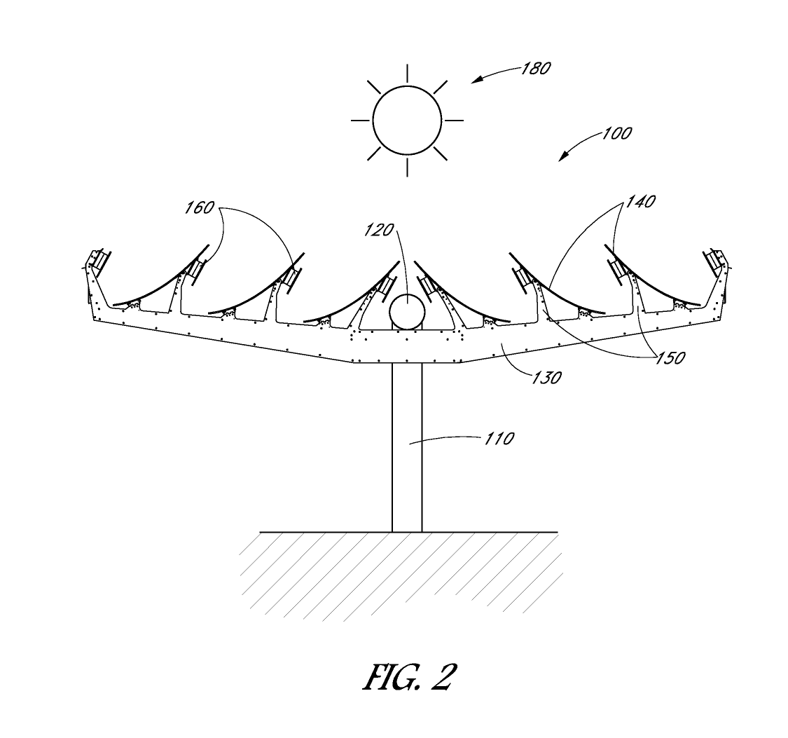

Turning now to FIG. 2, a solar tracker in the form of an example concentrated PV tracker is shown. The description of the controllers (central and local) and remote computing device from FIG. 1 applies equally to the tracker of FIG. 2 but is not repeated for ease of understanding.

As shown, solar collection system 100 is being irradiated by the sun 180. Solar system comprises pier 110, torque tube 120 supported by pier 110, at least one cross beam 130 coupled to torque tube 120, several solar concentrators or reflector elements 140 positioned and maintained by a support structure 150 which couples to one or more of the cross beams 130, and solar receivers 160. In some embodiments, support structure 150 couples one of the solar receivers 160 to one or more of the cross beams 130. In some embodiments, one or more of the solar receivers 160 is coupled to the rear, non-reflective side of one or more solar concentrators 140. The disclosed tracker controller embodiments can be configured to cause torque tube 120 to rotate the assembled and positioned solar concentrators 140 and solar receivers 160 to track the sun during the day. By tracking the sun, solar system 100 can receive optimum irradiance during hours of sunlight.

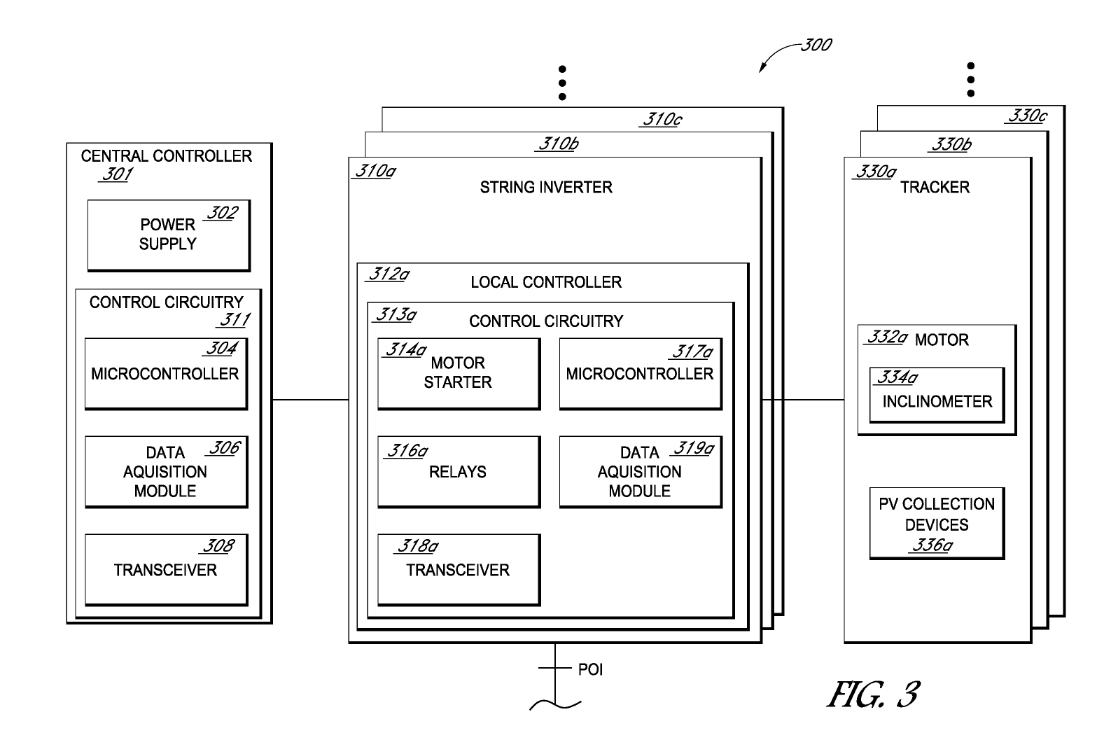

Turning now to FIG. 3, a block diagram of an example PV tracker control system 300 is shown. In the illustrated embodiment, central controller 301 is configured to communicate with a plurality of local controllers 312a, 312b, and 312c located in string inverters 310a, 310b, and 310c, respectively. Local controllers 312a, 312b, and 312c are then configured to communicate with trackers 330a, 330b, and 330c, respectively.

Note that although this simple configuration illustrates a single central controller and three trackers with respective string inverters and local controllers, other configurations exist. In fact, the disclosed structures techniques permit a much larger ratio of trackers to central controllers, which can reduce cost. For example, a single central controller can be configured to control a large number (e.g., 16, 32, 64, etc.) of local controllers and trackers.

Continuing the example of FIG. 3, central controller 301 can include power supply 302 and control circuitry 311. In one embodiment, power supply 302 can receive voltage, such as 480V power, for example, from the grid (connection to grid not explicitly shown), and convert the 480V power into a lower voltage for use by other components. As one example, power supply 302 can covert the 480V into 24V for use by microcontroller 304 and/or other components. In some embodiments, central controller 301 can also provide the 24V to the local controllers or tracker motor but, in other embodiments, one advantage of the disclosed configurations and structures is the ability to partition components that utilize 24V versus those that utilize 480V. Accordingly, components that utilize 24V can be centrally located in the central controller 301 and components that utilize 480V can be distributed to the local controller(s) 312a, 312b and 312c.

The control circuitry 311 of the central controller 301 can be circuitry configured to compute, analyze, send and/or receive an indication of data. In an example, the control circuitry of the central controller, local controllers, and/or the remote computing device can receive data, analyze that data, and compute the appropriate tracking angles and based on those computations. In one example, control circuitry 311 can provide an indication to the tracker motor to adjust an angle of the tracker based on the computed tracking angle. In some embodiments, for example, the control circuitry 311 can be configured to control one or more tracker motors. In an embodiment, the control circuitry 311 can include a microcontroller 304, data acquisition module 306, and transceiver 308.

Central controller 301 can also include data acquisition module 306. In one embodiment, data acquisition module 306 can receive telemetry data from the tracker, such as degree of inclination, temperature, wind speed, humidity, other weather information, location (e.g., GPS) data, among other examples. Such information can be received by data acquisition module 306 through the local controller as a pass-through, or it can be received directly from the tracker (e.g., from an inclinometer). As noted above, in some embodiments, the data acquisition module 306 can be alternatively located in the local controller 312, in the string inverter 310 (e.g., in the local controller 312), or can be located in the local and central controllers, as shown. For instance, some string inverters may already include a data acquisition module 319 and such equipment can be leveraged to also perform data acquisition for tracking at the local controller 312a thereby removing the need for a data acquisition module 306 at the central controller 301.

Data received by data acquisition module 306 can be processed by microcontroller 304 and a tracking angle can be calculated. In some embodiments, tracking angle computation can be performed entirely by the microcontroller 304 or additional remote input (e.g., from a remote computing device not shown) can be provided to central controller 300 based on the received telemetry data. As noted above, in some embodiments, the microcontroller 304 can be alternatively located in the local controller 312 in the string inverter 310 or can be located in the local and central controllers, as shown. For instance, some string inverters may already include a microcontroller and such equipment can be leveraged to also perform the tracking angle computation at the local controller thereby removing the need for a microcontroller 304 at the central controller 301.

In various embodiments, central controller 301 and the local controller 312a, 312b, 312c can include transceivers 318a, 318b, and 318c, respectively. Transceivers can permit wireless communication among the various controllers. Note that although not explicitly illustrated, local controllers 312a, 312b and 312c can also communicate amongst themselves and not just with the central controller 301. In various embodiments, various wireless protocols can be used, including a wireless mesh network protocol, cellular protocols, among others. In some embodiments, instead of or in addition to wireless transceivers, the central and/or local controllers can include wired communication systems, such as Ethernet, RS485, powerline communications, among other examples.

In some embodiments, the string inverters 310a, 310b, 310c may already include their own communication systems, whether wireless or wired. In such embodiments, the local controllers 312a, 312b and 312c may not need a separate communication system and can instead leverage the communication system of a respective string inverter housing the local controller.

In the illustrated embodiment, central controller 301 can provide control signals to the individual local controllers and receive telemetry data regarding the respective trackers from the local controllers, on a tracker-by-tracker basis. Such provided control signals and received telemetry data can be provide/received via a wireless or wired signal. In an example, an indication (e.g., control signal) from the central controller can be used to control and/or adjust the one or more tracker motors. As used herein, control signals and/or telemetry data can also be referred to as an indication.

In an embodiment, the local controller 312a can provide control signals to other local controllers 312b, 312c and receive telemetry data regarding the respective trackers from the other local controllers 312b, 312c, on a tracker-by-tracker basis. Such provided control signals and received telemetry data can be provide/received via a wireless or wired signal.

In an embodiment, local controller 312a can provide control signals to other local controllers 312b, 312c to be used to control and/or adjust the one or more tracker motors. As used herein, control signals and/or telemetry data can also be referred to as an indication.

As shown, each string inverter can house a respective local controller. For example, string inverter 310a can house local controller 312a, stringer inverter 310b can house local controller 312b, and so on.

The string inverters can receive DC power from the PV collection devices of a respective tracker and convert the DC power into AC power. The string inverter can then provide that AC power to the grid at the point of interconnect (“POI”) and in some embodiments, can provide AC power to an AC motor, such as motor 332a of tracker 330a. Not shown in FIG. 3, AC power can also be provided to central controller 301. In an embodiment, local controller 312a can include circuitry that can optimize whether the AC motor is powered by parasitic power from the string inverter output or from the grid.

In an embodiment, the local controller 312a can include control circuitry 313a. In one embodiment, the control circuitry 313a can include a motor starter 314a, relays 316a, transceiver 318a, microcontroller 317a and data acquisition module 319a.

The local controller 312a can also include motor starter 314a and relays 316a. Motor starter 314a can be configured to receive a control signal from central controller 301 and in response to the control signal, can energize one or more relays of relays 316a, which in turn energizes motor 332a to effectuate movement of tracker 330a. In one embodiment, relays 316a include a forward and reverse relay, such that one of the relays activates the forward movement of the motor and another relay activates reverse movement. In an example, local controller 312a can include transceiver 318a, as discussed above, to receive control signals from the central controller 301 and to provide telemetry data to the central controller 301.

In various embodiments, tracker 330a can include motor 332a and PV collection devices 336a. Tracker 330a can also include an inclinometer 334a configured to measure the angle of the tracker, which can be installed directly on the tracker or integrated inside the motor 332a. In one embodiment, inclinometer 334a can provide inclination data to local controller 312a, which can then provide the data to central controller 301.

In one embodiment, the motor 332a can be configured to operate at approximately the same voltage as an output of the first string inverter 310a. In an example, the motor 332a can be an AC motor configured to receive an AC voltage from the output of the string inverter. One advantage of using a higher voltage AC motor is to enable partitioning of the 480V and 24V components in the local and central controllers, respectively.

In some embodiments, the motor 332a can be configured to operate at a substantially lower voltage than an output of the first plurality of PV collection devices. In an example, motors 332a, 332b and 332c can be a DC motor, such as a 24V DC motor, configured to receive a DC voltage from the output of the plurality of PV collection devices 336a, 336b and 336c which can output, in some embodiments, at approximately 600V DC.

In other embodiments, motor 332a can be a DC motor, such as a 24V DC motor. For the 24V DC motor example, instead of utilizing motor starters or relays to control them, a control signal can be provided from the central controller 301 to the motor 332a. In such an example, the control aspects of the local controller 310a can be eliminated with the local controller 310a instead simply being used for local 24V power.

In some embodiments, the motors 332a, 332b and 332c can include control circuitry (e.g., similar to the control circuitry 313a, 313b and 313c), where the control circuitry can be configured to receive a control signal from the local controller 312a or the central controller 301 and in response to the control signal, move the tracker 330a. In an example, the motor 332a, 332b and 332c can receive an indication based on data, analyze that data, and compute the appropriate tracking angles and based on those computations, move the tracker in a forward or reverse direction. In one example, the control circuitry of the motor can include a microcontroller and/or a data acquisition module.

Although one example configuration is shown in FIG. 3, note that the distribution of components illustrated in central controller 301 and the local controllers can be different in other embodiments. For example, in one embodiment, a data acquisition module 319a can be located in the local controller 312a in the string inverter 310a rather than or in addition to being located in the central controller 301 (referring to 319a of FIG. 3).

As another example, in one embodiment, because the string inverter can include its own communication system and data acquisition system, the local controller 312a can leverage those systems and further be streamlined. In one such embodiment, the local controller 312a may only include motor starters and firmware.

As yet another example, in some embodiments, a single motor starter can be used to power multiple trackers. Accordingly, in some embodiments, each local controller 312a may not necessarily include control circuitry. Instead, only some local controllers 312a may include control circuitry (e.g., 1 out of every 2, 4, 8, 16, etc.). Or, in some instances, each local controller may include control circuitry for redundancy purposes but only some may be actively used when using a single motor starter to power multiple trackers.

Thus, in various embodiments, the power plant control system can vary in degrees of distribution, from the more centralized configuration illustrated in FIG. 3 to a more distributed approach where more of the control components are located in the local controller 312a.

In an embodiment, the central controller 301 can include control components configured to operate at substantially lower voltage than does control circuitry 313a of local controller 312a. In an example, the illustrated embodiment allows for the 24V control circuitry 311 to be located in one controller, the central controller, and 480V components to be located in the local controllers 312a, 312b and 312c. Because the local controllers have access to the 480V output of the string inverter, additional routing of power (e.g., 24V DC power) from the central controller to the tracker is not necessary, thereby resulting in a system cost reduction. Moreover, by aggregating control circuitry 311 for multiple trackers (e.g., 16, 32, 64, etc.) in a single central controller but distributing motor circuitry to the string inverters, additional cost savings can be realized.

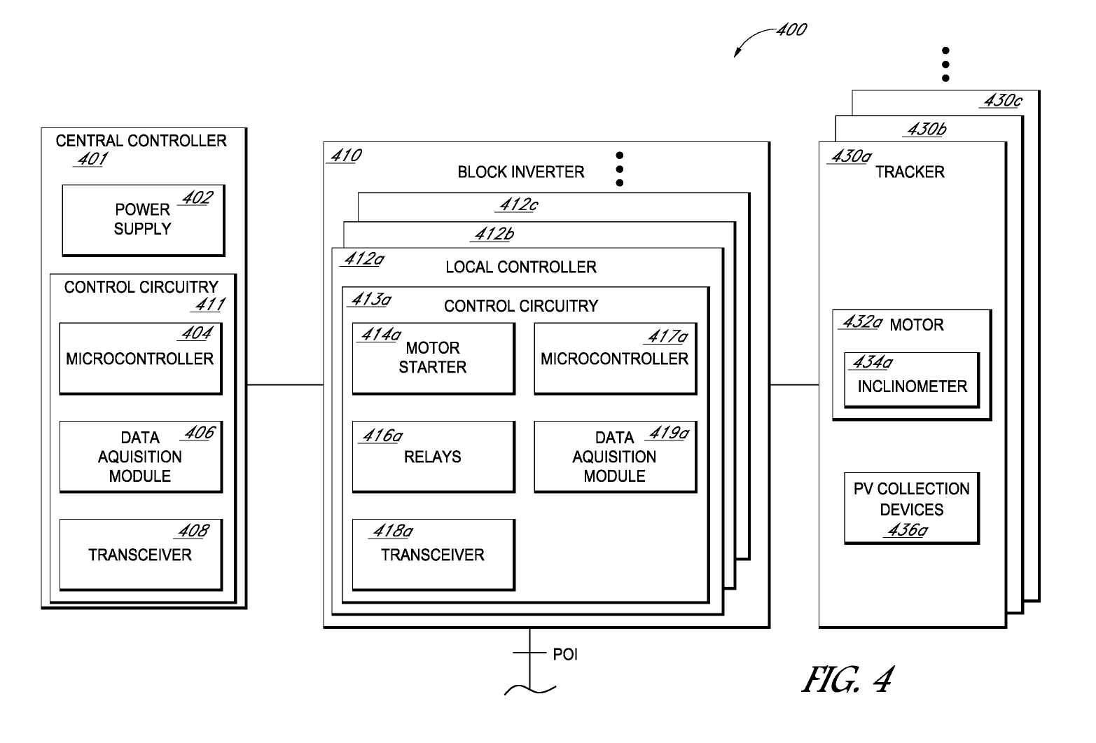

With reference to FIG. 4, a block diagram of an example PV tracker control system 400 is shown, according to some embodiments. As shown, the block diagram of FIG. 4 has similar reference numbers to elements of FIG. 3, wherein like reference numbers refer to similar elements throughout the figures. In an embodiment, the central controller 401, local controllers 412a, 412b, 412c and trackers 430a, 430b, 430c of FIG. 4, including their respective component parts (e.g., motors 432a, 432b and 432c, etc.), are substantially similar to the central controller 301, local controllers 312a, 312b, 312c and trackers 330a, 330b 330c of FIG. 3 except as described below. Therefore the description of corresponding portions of FIG. 3 applies equally to the description of FIG. 4.

In the illustrated embodiment, central controller 401 can be configured to communicate with a plurality of local controllers 412a, 412b, and 412c located in a block inverter 410. Local controllers 412a, 412b, and 412c are then configured to communicate with trackers 430a, 430b, and 430c, respectively.

Note that although this configuration illustrates a single central controller, a block inverter, and three trackers, other configurations can exist. In one example, the block inverter, including a central controller 410 can be coupled to the trackers 430a, 430b, and 430c, via power collection units, where the power collection units can be configured to combine the output voltage of a plurality of trackers. For example, a single central controller 411 can be configured to control a larger number (e.g., 16, 32, 64, etc.) of local controllers and trackers. In some embodiments, the block inverter 410 can include, or house, the central controller 401.

Continuing the example of FIG. 4, central controller 401 can include a power supply 402 and control circuitry 411. In an embodiment, the power supply 402 and control circuitry 411 of FIG. 4 are substantially similar to the power supply 302 and control circuitry 311 of FIG. 3, including their respective component parts (e.g., motor starter 414a, relays 416a, transceivers 418a, data acquisition module 419a, microcontroller 417a, etc.). Therefore the description of the power supply 302 and control circuitry 311 of FIG. 3 applies equally to the description of the power supply 402 and control circuitry 411 of FIG. 4, including their respective component parts, except as described below.

Central controller 401 can also include data acquisition module 406. As noted above, in some embodiments, the data acquisition module 406 can be alternatively located in the local controller 412a in the block inverter 410, as shown. For instance, a local controller 412a embedded in the block controller 410 may already include a data acquisition module 419 and such equipment can be leveraged to also perform data acquisition for tracking at the local controller 419a thereby removing the need for a data acquisition module 406 at the central controller 401.

Data received by data acquisition module 406 can be processed by microcontroller 404 and a tracking angle can be calculated. As noted above, in some embodiments, the microcontroller 404 can be alternatively located in the local controller 412 in the block inverter 410 or can be located in the local and central controllers, as shown. For instance, some block inverters 410 may already include a microcontroller 417 and such equipment can be leveraged to also perform the tracking angle computation at the local controller thereby removing the need for a microcontroller 404 at the central controller 401.

As noted above, in some embodiments, the data acquisition module 419a, microcontroller 417a, transceivers 418a can be alternatively located in a local controller 412a in the block inverter 410 or can be located in both the local and central controllers, as shown.

In some embodiments, the block inverter 410 may already include its own communication system, whether wireless or wired. In such embodiments, the local controllers 412a, 412b and 412c may not need a separate communication system and can instead leverage the communication system of the block inverter 410 housing the local controllers 412a, 412b and 412c.

In the illustrated embodiment, central controller 401 can provide control signals to the individual local controllers and receive telemetry data regarding the respective trackers from the local controllers, on a tracker-by-tracker basis. Such provided control signals and received telemetry data can be provide/received via a wireless or wired signal. In an example, a control signal from the central controller 411 can be used to control and/or adjust the one or more tracker motors. As used herein, control signals and/or telemetry data can also be referred to as an indication

In an embodiment, the local controller 412a can provide control signals to other local controllers 412b, 412c and receive telemetry data regarding the respective trackers from the other local controllers 412b, 412c, on a tracker-by-tracker basis. Such provided control signals and received telemetry data can be provided/received via a wireless or wired signal.

The block inverter 410 can house one or a plurality of local controllers 412a, 412b and 412c. For example, block inverter 410 can house local controller 412a, 412b, and so on.

The block inverter 410 can receive DC power from the PV collection devices of a plurality of trackers and convert the DC power into AC power. The block inverter 410 can then provide that AC power to the grid at the point of interconnect (“POI”) and in some embodiments, can provide AC power to an AC motor, such as motor 432a of tracker 430a. Not shown in FIG. 4, AC power can also be provided to central controller 401. In an embodiment, local controller 412a can include circuitry 413a that can optimize whether the AC motor is powered by parasitic power from the block inverter 410 output or from the grid.

In an embodiment, the local controller 412a can include control circuitry 413a. In one embodiment, the control circuitry 413a can include a motor starter 414a, relays 416a, transceiver 418a, microcontroller 417a and data acquisition module 419a.

In various embodiments, tracker 430a can include motor 432a and PV collection devices 436a. Tracker 430a can also include an inclinometer 434a configured to measure the angle of the tracker, which can be installed directly on the tracker or integrated inside the motor 432a. In one embodiment, inclinometer 434a can provide inclination data to local controller 412a, which can then provide the data to central controller 401.

In one embodiment, the motor 432a can be configured to operate at approximately the same voltage as an output of the block inverter 410. In an example, the motor 432a can be an AC motor configured to receive an AC voltage from the output of the block inverter 410. One advantage of using a higher voltage AC motor is to enable partitioning of the 480V and 24V components in the local and central controllers, respectively.

In some embodiments, the motor 432a can be configured to receive voltage from the block inverter 410 and operate at a substantially lower voltage than an output of the PV trackers. In an example, motors 432a, 432b and 432c can be a DC motor, such as a 24V DC motor, configured to receive a DC voltage from the output of the plurality of PV collection devices 436a, 436b and 436c which can output, in some embodiments, at approximately 600V DC. In one example, the DC motor can be configured to receive a DC voltage from the output of the plurality of PV collection devices 436a, 436b and 436c via power collection units. In an example, the power collection unit can combine the output voltage of a plurality of PV trackers 430a, 430b and 430c to the block inverter 410.

Although one example configuration is shown in FIG. 4, note that the distribution of components illustrated in central controller 401 and the local controllers can be different in other embodiments. For example, in one embodiment, a data acquisition module 419a can be located in the local controller 412a in the block inverter 410a rather than or in addition to being located in the central controller 401 (referring to 419a of FIG. 4).

As another example, in one embodiment, because the block inverter 410 can include its own communication system and data acquisition system, the local controller 412a can leverage those systems and further be streamlined. In one such embodiment, the local controller 412a may only include motor starters and firmware.

As yet another example, in some embodiments, a single motor starter can be used to power multiple trackers. Accordingly, in some embodiments, each local controller 412a may not necessarily include control circuitry 413a. Instead, only some local controllers 412a may include control circuitry (e.g., 1 out of every 2, 4, 8, 16, etc.). Or, in some instances, each local controllers 412a, 412b, 412c may include control circuitry 413a, 413b, 413c for redundancy purposes but only some may be actively used when using a single motor starter to power multiple trackers.

Thus, in various embodiments, the power plant control system can vary in degrees of distribution, from the more centralized configuration illustrated in FIG. 4 to a more distributed approach where more of the control components are located in the local controller 412a.

In an embodiment, the central controller 401 can include control components 411 configured to operate at substantially lower voltage than does control circuitry 413a of local controller 412a. In an example, the illustrated embodiment allows for the 24V control circuitry to be located in one controller, the central controller, and 480V components to be located in the local controllers. Because the local controllers have access to the 480V output of the block inverter 410, additional routing of power (e.g., 24V DC power) from the central controller to the tracker is not necessary, thereby resulting in a system cost reduction. Moreover, by aggregating control circuitry for multiple trackers (e.g., 16, 32, 64, etc.) in a single central controller but distributing control circuitry to the local controllers, additional cost savings can be realized.

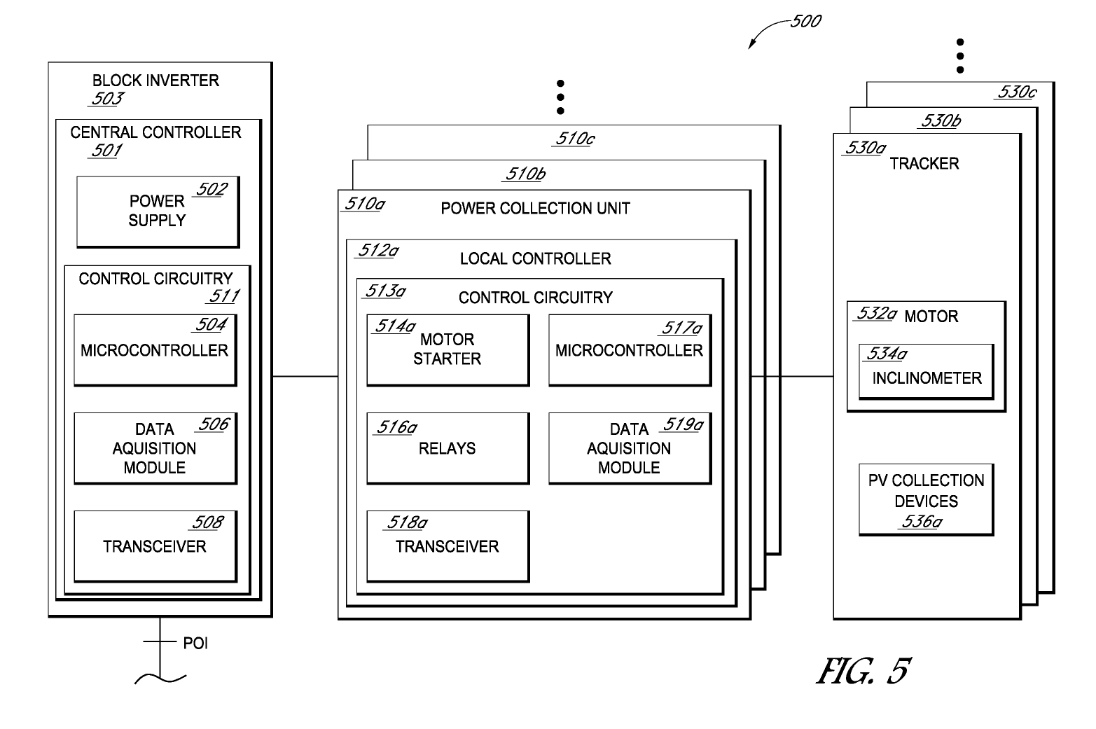

With reference to FIG. 5, a block diagram of an example PV tracker control system 500 is shown, according to some embodiments. As shown, the block diagram of FIG. 5 has similar reference numbers to elements of FIG. 3 and FIG. 4, wherein like reference numbers refer to similar elements throughout the figures. In an embodiment, the central controller 501, local controllers 512a, 512b, 512c and trackers 530a, 530b, 530c of FIG. 5, including their respective component parts (e.g., motors 532a. 532b and 532c, etc.), are substantially similar to the central controller 301/401, local controllers 312a/412a, 312b/412b, 312c/412c and trackers 330a/430a, 330b/430b, 330c/430c of FIGS. 3 and 4 except as described below. Therefore the description of corresponding portions of FIG. 5 applies equally to the description of FIGS. 3 and 4.

In the illustrated embodiment, the central controller 501 can be configured to communicate with a plurality of local controllers 512a, 512b and 512c located in the plurality of power collection units 510a, 510b and 510c, respectively. Local controllers 512a, 512b, and 512c are then configured to communicate with trackers 530a, 530b, and 530c, respectively.

Note that although this configuration illustrates a single central controller located in a block inverter, three power collection units, and three trackers, other configurations exist. In one example, the central controller need not be located in the block inverter 503, and in one embodiment, can be located at a remote site (e.g., at a different location from the tracker system). For example, a single central controller 501 can be configured to control a larger number (e.g., 16, 32, 64, etc.) of local controllers and trackers. In another example, a different number of power collection units (e.g., combiner boxes) than trackers can be implemented.

Continuing the example of FIG. 5, central controller 501 can include a power supply 502 and control circuitry 511. In an embodiment, the power supply 502 and control circuitry 511 of FIG. 5 are substantially similar to the power supply 302/402 and control circuitry 311/411 of FIG. 3 and FIG. 4, including their respective component parts (e.g., motor starter 514a, relays 516a, transceivers 518a, data acquisition module 519a, microcontroller 517a, etc.). Therefore the description of the power supply 302/402 and control circuitry 311/411 of FIG. 3 and FIG. 4 applies equally to the description of the power supply 502 and control circuitry 511 of FIG. 5, except as described below.

Central controller 501 can also include data acquisition module 506. As noted above, in some embodiments, the data acquisition module 506 can be alternatively located in the local controller 512a in the power collection unit 510a, as shown. For instance, a local controller 512a located in the power collection unit 510a may already include a data acquisition module 519a and such equipment can be leveraged to also perform data acquisition for tracking at the local controller thereby removing the need for a data acquisition module 506 at the central controller 501.

Data received by data acquisition module 506 can be processed by microcontroller 504 and a tracking angle can be determined or calculated. As noted above, in some embodiments, the microcontroller 504 can be alternatively located in the local controller 512a in the power collection unit 510a or can be located in the local and central controllers, as shown. For instance, some power collection units 510a, 510b, 510c may already include a microcontrollers 517a, 517b, 517c and such equipment can be leveraged to also perform the tracking angle computation at the local controllers 512a, 512b, 512c thereby removing the need for a microcontroller 504 at the central controller 501.

As noted above, in some embodiments, the data acquisition module 519a, microcontroller 517a, transceivers 518a can be alternatively located in a local controller 512a in the power collection unit 510a or can be located in both the local and central controllers, as shown.

In the illustrated embodiment, central controller 501 can provide control signals to the individual local controllers and receive telemetry data regarding the respective trackers from the local controllers, on a tracker-by-tracker basis. Such provided control signals and received telemetry data can be provide/received via a wireless or wired signal. In an example, a control signal from the central controller 501 can be used to control and/or adjust the one or more tracker motors. As used herein, control signals and/or telemetry data can also be referred to as an indication

In an embodiment, the local controller 512a can provide control signals to other local controllers 512b, 512c and receive telemetry data regarding the respective trackers from the other local controllers 512b, 512c, on a tracker-by-tracker basis. Such provided control signals and received telemetry data can be provide/received via a wireless or wired signal.

The power collection unit 510a can house a local controller 512a. In an example, there can be multiple power collection units 510b, 510c, each including a corresponding local controller 512b, 512c, and so on.

The power collection unit can combine DC power from a PV collection devices to an output of a PV trackers. In an example the power collection units 510a, 510b and 510c can combine DC power from PV collection devices 536a, 536b, 536c to the output of the plurality of trackers 530a, 530b and 530c, respectively. The power collection units 510a, 510b and 510c can be coupled to the block inverter 503. The block inverter 503 can convert the DC power from the power collection units 510a, 510b and 510c to AC power and provide that AC power to the grid at the point of interconnect (“POI”) and in some embodiments, can provide AC power to an AC motor, such as motor 532a of tracker 530a. AC power can also be provided to central controller 501. In an embodiment, local controller 512a can include circuitry 513a that can optimize whether the AC motor is powered by parasitic power from the PV collection devices 536a, 536b and 536c or from the block inverter 503 output or from the grid.

In an embodiment, the local controller 512a can include control circuitry 513a. In one embodiment, the control circuitry 513a can include a motor starter 514a, relays 516a, transceiver 518a, microcontroller 517a and data acquisition module 519a.

In various embodiments, tracker 530a can include motor 532a and PV collection devices 536a. Tracker 530a can also include an inclinometer 534a configured to measure the angle of the tracker, which can be installed directly on the tracker or integrated inside the motor 532a. In one embodiment, inclinometer 534a can provide inclination data to local controller 512a, which can then provide the data to central controller 501.

In some embodiments, the motor 532a can be configured to receive voltage from the power collection units 512a, 512b and 512c and operate at a substantially lower voltage than an output of the PV trackers. In an example, motors 532a, 532b and 532c can be a DC motor, such as a 24V DC motor, configured to receive a DC voltage from the output of the plurality of PV collection devices 536a, 536b, 536c which can operate, in some embodiments, at approximately 600V DC. In an example, motors 532a, 532b and 532c can be a DC motor, such as a 24V DC motor, configured to receive a DC voltage from the output of the plurality of PV collection devices 536a, 536b, 536c via the power collection units 510a, 510b, 510c.

Although one example configuration is shown in FIG. 5, note that the distribution of components illustrated in central controller 501 and the local controllers 512a, 512b and 512c can be different in other embodiments. In one example, a data acquisition module 519a can be located in the local controller 512a in the power collection unit 510a rather than or in addition to being located in the central controller 501 (referring to 519a of FIG. 5).

As another example, in some embodiments, a single motor starter can be used to power multiple trackers. Accordingly, in some embodiments, each local controller 512a may not necessarily include control circuitry 513a. Instead, only some local controllers 512a may include control circuitry (e.g., 1 out of every 2, 4, 8, 16, etc.). Or, in some instances, each local controller may include control circuitry for redundancy purposes but only some may be actively used when using a single motor starter to power multiple trackers.

Thus, in various embodiments, the power plant control system can vary in degrees of distribution, from the more centralized configuration illustrated in FIG. 4 to a more distributed approach where more of the control components are located in the local controller 512a (e.g., as in FIGS. 3 and 5).

In an embodiment, the central controller 501 can include control components 511 configured to operate at substantially lower voltage than does control circuitry 513a of local controller 512a. Moreover, by aggregating control circuitry for multiple trackers (e.g., 16, 32, 64, etc.) in a single central controller but distributing control circuitry to the local controllers, additional cost savings can be realized.

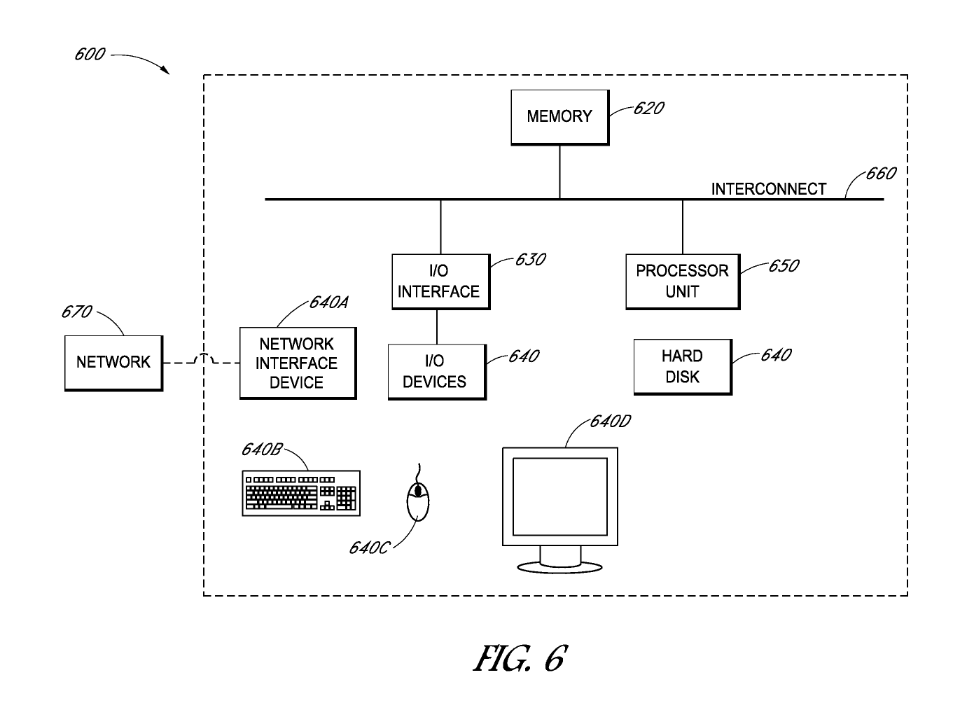

Turning now to FIG. 6, an example computer system 600 configured to implement one or more portions of the disclosed structures or techniques is shown. Computer system 600 can be any suitable device, including, but not limited to a personal computer system, desktop computer, laptop or notebook computer, mainframe computer system, server farm, web server, handheld computer or tablet device, workstation, network computer, mobile device, etc. Computer system 600 can also be any type of network peripheral device such as a storage device, switch, modem, router, etc. Although a single computer system 600 is shown in FIG. 6 for convenience, system 600 can also be implemented as two or more computer systems operating together.

As shown, computer system 600 includes a processor unit 650, memory 620, input/output (I/O) interface 630 coupled via an interconnect 660 (e.g., a system bus). I/O interface 630 is coupled to one or more I/O devices 640.

In various embodiments, processor unit 650 can include one or more processors. In some embodiments, processor unit 650 can include one or more coprocessor units. In some embodiments, multiple instances of processor unit 650 can be coupled to interconnect 660. Processor unit 650 (or each processor within 650) can contain a cache or other form of on-board memory. In general computer system 600 is not limited to any particular type of processor unit or processor subsystem.

Memory 620 is usable by processor unit 650 (e.g., to store instructions executable by and data used by unit 650). Memory 620 may be implemented by any suitable type of physical memory media, including hard disk storage, floppy disk storage, removable disk storage, flash memory, random access memory (RAM—SRAM, EDO RAM, SDRAM, DDR SDRAM, Rambus® RAM, etc.), ROM (PROM, EEPROM, etc.), and so on. Memory 620 may consist solely of volatile memory in one embodiment.

Memory in computer system 600 is not necessarily limited to memory 620. Rather, computer system 600 may be said to have a “memory subsystem” that includes various types/locations of memory. For example, the memory subsystem of computer system 600 may, in one embodiment, include memory 620, cache memory in processor unit 650, storage on I/O devices 640 (e.g., a hard drive, storage array, etc.), and so on. Accordingly, the phrase “memory subsystem” is representative of various types of possible memory media within computer system 600. The memory subsystem of computer 600 may store program instructions executable by processor unit 650, including program instructions executable to implement the various techniques disclosed herein.

I/O interface 630 may represent one or more interfaces and may be any of various types of interfaces configured to couple to and communicate with other devices, according to various embodiments. In one embodiment, I/O interface 630 is a bridge chip from a front-side to one or more back-side buses. I/O interface 630 may be coupled to one or more I/O devices 640 via one or more corresponding buses or other interfaces. Examples of I/O devices include storage devices (hard disk (e.g., 640), optical drive, removable flash drive, storage array, SAN, or an associated controller), network interface devices (e.g., 640A, which may couple to a local or wide-area network), user interface devices (e.g., mouse 640C, keyboard 640B, display monitor 640D) or other devices (e.g., graphics, sound, etc.). In one embodiment, computer system 600 is coupled to a network 670 via a network interface device 640A. I/O devices 640 are not limited to the examples listed above. All depicted I/O devices 640 need not be present in all embodiments of computer system 600.

Computer system 600 (or multiple instances of computer system 600) may be used to implement the various techniques described herein. Articles of manufacture that store instructions (and, optionally, data) executable by a computer system to implement various techniques disclosed herein, such as processing data received from a data acquisition module, determining tracking angles, and providing instructions to a motor to move a tracker, are also contemplated. These articles of manufacture include tangible computer-readable memory media. The contemplated tangible computer-readable memory media include portions of the memory subsystem of computer system 600 (without limitation SDRAM, DDR SDRAM, RDRAM, SRAM, flash memory, and various types of ROM, etc.), as well as storage media or memory media such as magnetic (e.g., disk) or optical media (e.g., CD, DVD, and related technologies, etc.). The tangible computer-readable memory media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A photovoltaic (PV) system, comprising:
a first tracker that includes a first plurality of PV collection devices;
a first motor configured to adjust an angle of the first tracker; and
a first inverter coupled to an output of the first plurality of PV collection devices, wherein the first inverter includes a first local controller comprising control circuitry configured to control the first motor.

2. The PV system of claim 1, further comprising:
a central controller configured to provide a first indication to the first local controller, wherein the first indication is usable by the control circuitry of the first local controller to control the first motor.

3. The PV system of claim 2, wherein the first indication is a tracking angle.

4. The PV system of claim 2, wherein the central controller comprises:
a data acquisition module configured to receive telemetry data; and
a microcontroller configured to:
determine a tracking angle based on the telemetry data received from the data acquisition module; and
provide the first indication indicative of the tracking angle to the first local controller.

5. The PV system of claim 2, wherein the central controller includes control circuitry configured to provide the first indication to the first local controller, wherein the control circuitry of the central controller is configured to operate at a substantially lower voltage than control circuitry of the first local controller.

6. The PV system of claim 1, wherein the first local controller is configured to compute a tracking angle and provide a first indication to the first motor.

7. The PV system of claim 1, wherein the first local controller comprises:
a microcontroller configured to:
determine a tracking angle based on telemetry data received from a data acquisition module, and
provide a first indication indicative of the tracking angle to the control circuitry, wherein the control circuitry is configured to use the first indication to control the first motor.

8. The PV system of claim 1, wherein the first tracker includes the first motor.

9. The PV system of claim 1, wherein the first local controller is configured to receive voltage from the first inverter, an electrical grid, or a battery.

10. The PV system of claim 1, wherein the first motor is configured to receive voltage from the first inverter, an electrical grid, or a battery.

11.-18. (canceled)

19. A photovoltaic (PV) system, comprising:
first and second trackers that includes a first and second plurality of PV collection devices, respectively;
a first motor configured to adjust an angle of the first tracker;
a block inverter coupled to an output of the first and second trackers; and
a first local controller comprising control circuitry configured to control the first motor.

20. The PV system of claim 19, wherein the block inverter includes the first local controller.

21. The PV system of claim 19, further comprising:
a central controller configured to provide a first indication to the first local controller, wherein the first indication is usable by the control circuitry of the first local controller to control the first motor.

22. The PV system of claim 21, wherein the block inverter includes the central controller.

23.-28. (canceled)

29. The PV system of claim 19, further comprising:
a second motor configured to adjust an angle of the second tracker; and
a second local controller comprising control circuitry configured to control the second motor, wherein the block inverter includes the first and second local controller.

30.-36. (canceled)

37. A photovoltaic (PV) system, comprising:
first and second trackers that includes a first and second plurality of PV collection devices, respectively;
a first motor configured to adjust an angle of the first tracker;
a first local controller comprising control circuitry configured to control the first motor; and
a first power collection unit configured to combine the output of the first plurality PV collection devices to the output of the first tracker, wherein the first power collection unit includes the first local controller.

38. The PV system of claim 37, further comprising:
a block inverter coupled to an output of the first tracker, wherein the block inverter is configured to receive a plurality of output from a plurality of trackers.

39. The PV system of claim 38, wherein the block inverter includes the central controller.

40. The PV system of claim 37, further comprising:
a central controller configured to provide a first indication to the first local controller, wherein the first indication is usable by the control circuitry of the first local controller to control the first motor.

41.-42. (canceled)

43. The PV system of claim 37, further comprising:
a second motor configured to adjust an angle of the second tracker;
a second local controller comprising control circuitry configured to control the second motor; and
a second power collection unit configured to combine the output of the second plurality of PV collection devices to the output of the second tracker, wherein the second power collection unit includes the second local controller.

44.-46. (canceled)
